(19) United States
(12) Patent Application Publication
(10) Pub. No.: US 2013/0325706 A1
(43) Pub. Date: Dec. 5, 2013

(54) SYSTEM, METHOD, APPARATUS, AND COMPUTER PROGRAM PRODUCT FOR IMPROVED PAYMENT PROCESSING

(71) Applicants: David L. Wilson, Palmetto Bay, FL (US); Carlos F. Rodriguez Buehl, Miami, FL (US); Pilar E. Rodriguez, Palmetto Bay, FL (US); Douglas Hathaway, Cutler Bay, FL (US)

(72) Inventors: David L. Wilson, Palmetto Bay, FL (US); Carlos F. Rodriguez Buehl, Miami, FL (US); Pilar E. Rodriguez, Palmetto Bay, FL (US); Douglas Hathaway, Cutler Bay, FL (US)

(73) Assignee: DADESYSTEMS, LLP, Miami, FL (US)

(21) Appl. No.: 13/486,497

(22) Filed: Jun. 1, 2012

(51) Int. Cl. G06Q 20/14; G06Q 20/22

(52) U.S. Cl. 705/40; 705/39

(57) ABSTRACT

A method for processing paper payments is provided. The method may include, by a payment processing apparatus, preloading account data for accounts for which a payment may be received, extracting payment details on a payment document, and identifying an account for a payment based on at least the preloaded account data. The method may additionally include providing the ability for a user to correct or validate a payment, as well as providing various searching capabilities for a user to accurately identify an account. The method may also include identifying physical characteristics of a payment, and/or a payment source, and generating an output file to be used in a payment posting process. Corresponding systems, apparatuses, and computer program products are also provided.

### TECHNOLOGICAL FIELD

Embodiments of the present invention relate generally to computer technology and, more particularly, relate to systems, methods, apparatuses, and computer program products for processing paper payments.

### BACKGROUND

Financial institutions, corporations, proprietorships, sole proprietors, and individuals are examples of entities who may receive large numbers of paper payment documents via mail. These payment documents may be received at lockboxes serviced by third party remittance service providers. A remittance service provider is responsible for processing paper payments and ensuring payments are debited from the payer account and deposited to the payee's account. Checks are a common form of payment, and by directing such payments to centralized payment processing locations, customers can ensure monies are deposited into their accounts as soon as possible, and attain increased efficiency with regard to processing checks and other paper payments.

In existing payment processing systems, traditional processes generally involve sorting incoming payment documents into distinct groups by payment sources, company, and association. In many cases, sorting is driven by the needs of a capture system, a destination accounting system, and/or balancing criteria. Inevitably, these factors may engender many and numerous sorts. As a sorting process is typically manual in nature, this portion of the payment processing may be labor intensive, with many human input points. These human input points may generate sorting or keying errors that lead to an unacceptable rate of misapplied, rejected, or excepted items.

### BRIEF SUMMARY OF SOME EXAMPLE EMBODIMENTS

Systems, methods, apparatuses, and computer program products are herein provided for improving paper payment processing. Embodiments provided herein may provide several advantages to remittance processing providers, as well as or companies employing lockbox systems or in-house paper payment processing. Improving the efficiency and accuracy of payment processing systems may ultimately result in savings for a remittance processing provider as well as their clients, potentially due to both reduced labor costs for initial processing and also a reduction in time spent on error correction. Additionally, customers making paper payments may see a reduction in errors on their accounts.

In a first example embodiment, an apparatus for processing payments is provided, comprising processing circuitry configured to cause the apparatus to preload account data, receive scanned data derived from scanning a payment document, extract payment details from the scanned data, identify an intended account for the payment to be applied to by utilizing the preloaded account data, and correlate the payment details to the identified account.

Additionally, the apparatus of some such example embodiments may comprise processing circuitry configured to cause the apparatus to receive an image of a billing statement associated with the payment. In some embodiments, the preloaded account data may include details regarding one or more expected payments, or bills. In another embodiment, identifying an account may also comprise associating information on the image of the payment document with previous payment information. In some embodiments, the processing circuitry may be configured to identify a payment source, such as a personal check or credit card, and in others, may be further configured to accept payments presorted by physical characteristics, such as whether or not the payment includes a billing statement. Some example embodiments may provide an apparatus comprising processing circuitry configured to generate a payment posting output file or database update.

Furthermore, in another embodiment, the apparatus may comprise processing circuitry that may be configured to cause the apparatus to display scanned data, account details associated with an identified account, and extracted payment details and to receive corrected payment details and an indication to correlate a payment to the account. In some embodiments, identifying an account may comprise any combination of receiving search criteria, identifying potential accounts partially satisfying the search criteria, causing the display of the potential account, and receiving selection of an account to which the payment is intended to be posted.

In one embodiment, a method for processing payments is provided. The method comprises preloading account data, receiving scanned data derived from scanning a payment document, extracting payment details from the scanned data, identifying an account associated with the payment document based on the preloaded account data, and correlating the payment details to the account. In an additional embodiment, the method further comprises receiving scanned data derived from scanning a billing statement received with a payment instrument. In some embodiments the preloaded account data may comprise information regarding one or more expected payments. Additionally, in some embodiments, identifying an account may comprise associating extracted payment details with previous payment information. The method of another embodiment may further comprise receiving payment documents presorted by their physical characteristics.

In an additional embodiment, a method may cause display of an scanned data, account details, and extracted payment details. The method may further comprise receiving corrected payment details and receiving an indication to correlate a payment to the account. In an additional embodiment, identifying an account may comprise identifying a plurality of potential accounts, causing display of the accounts, and receiving selection of an account. In some embodiments the method may also comprise receiving search criteria, identifying at least one potential account at least partially matching the search criteria, displaying the potential accounts, and receiving selection of one of the potential accounts that are displayed. In some embodiments, such methods may be implemented on a web-based system.

In another embodiment, a computer program product is provided, comprising at least one non-transitory computer-readable medium having computer-readable program instructions stored therein, which when performed by an apparatus, cause the apparatus to preload account data, receive scanned data from a payment document, identify an account associated with the payment document based on at least the preloaded account data, extract payment details from the scanned image, and correlate the payment details to the account.

The above summary is provided merely for purposes of summarizing some example embodiments of the invention so as to provide a basic understanding of some aspects of the invention. These and other embodiments of systems, methods, apparatuses, and computer program products are provided that facilitate improved paper payment processing. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates a system for processing payments according to some example embodiments;

FIG. 2 illustrates a block diagram of a payment processing apparatus in accordance with some example embodiments;

FIG. 3 illustrates a flowchart according to some example embodiments;

FIG. 4 illustrates a flowchart according to some example embodiments;

FIG. 5 illustrates a flowchart according to some example embodiments;

FIG. 6a-c illustrates user interface displays according to some example embodiments;

FIG. 7 illustrates a flowchart according to some example embodiments;

FIG. 8 illustrates a flowchart according to some example embodiments;

FIG. 9 illustrates a flowchart according to some example embodiments; and

FIG. 10 illustrates a sequence of operations according to some example embodiments.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device and/or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent to the another computing device via one or more interlinking computing devices, such as, for example, one or more servers, relays, routers, network access points, base stations, and/or the like.

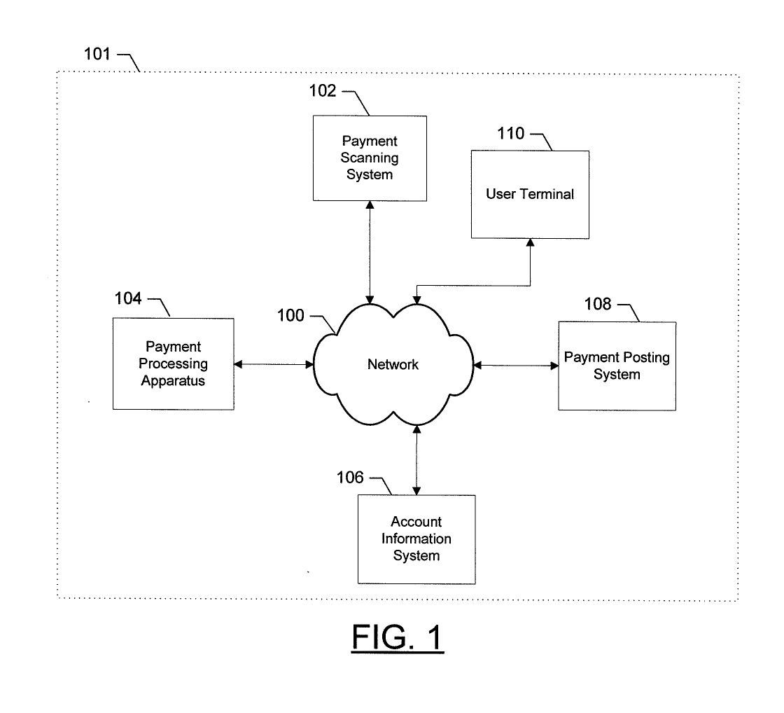

FIG. 1 illustrates a system 101 for processing payments according to some example embodiments. It will be appreciated that the system 101 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for processing payments, numerous other configurations may also be used to implement embodiments of the present invention.

The system 101 may include one or more payment scanning systems 102, which may be configured to scan paper payment documents, capture digital images of the paper payment documents, and provide the captured digital images and/or other scanned data to a payment processing apparatus 104. In this regard, the scanned data may comprise an image of a payment document, and/or digital data representing information on a payment document. For example, the scanned data may comprise digital data representing text that may be printed and/or written or a payment document which may, for example, be derived through use of optical character recognition (OCR), magnetic ink character recognition (MICR), and/or other similar character recognition techniques. Payment scanning system 102 may include any combination of OCR scanners, MICR scanners, barcode scanners, TWAIN enabled scanners, ferrite scanners, and/or any other scanning device capable of scanning a payment document and providing a digital image of the payment document and/or other scanned data representative of information of the paper payment documents. Such payment documents may include, but are not limited to payment instruments such as personal checks, money orders, business checks, traveler's checks, cashier's checks, government checks, and credit card charge authorization forms, and/or the like. Some payment documents may be sent directly by a customer. Additionally or alternatively, a payment document may be generated by a bank, credit union, and/or other financial institution at the instruction of a customer, for example, by an online bill pay service. Some payment documents scanned by payment scanning system 102 may optionally include a billing statement, which may contain account information billing information, and/or the like. Such a billing statement may have been provided to the customer to be returned with a payment. Accordingly, a payment document may comprise any paper payment instrument, billing statement, and/or the like. A billing statement may comprise a bill, invoice, coupon, and/or the like. A coupon may be a payment summary for mailing with a paper payment. A payment document set may include a combination of images capturing payment documents associated with a single payer. In instances in which a payment document set includes multiple payment instruments, the multiple payment instruments may include payment instruments from a single payer, or may comprise payment instruments from a plurality of payer's to be paid on behalf of a single payer account, or multiple accounts on behalf of multiple payers. Accordingly, a payment document set may include scanned data representing any number of payment instruments, billing statement, and/or the like.

A payment scanning system 102 may be configured to provide scanned data to the payment processing apparatus 104 via any of a variety of methods dependent upon the configuration of the system 101. For example, in embodiments in which a payment scanning system 102 is disposed remotely from the payment processing apparatus 104, scanned data may be provided to the payment processing apparatus 104 via a network 100, by a variety of connections. Network 100 may be embodied in a local area network, the Internet, any other form of a network, or in any combination thereof, including proprietary private and semi-private networks and public networks. The network 106 may comprise a wireline network, wireless network (e.g., a cellular network, wireless local area network, wireless wide area network, some combination thereof, or the like), or a combination thereof, and in some example embodiments comprises at least a portion of the Internet. As another example, a payment scanning system 102 may be directly coupled to a payment processing apparatus 104, and scanned data may be provided from a payment scanning system 102 to the payment processing apparatus 104 via a direct connection between the payment processing apparatus 104 and payment scanning system 102.

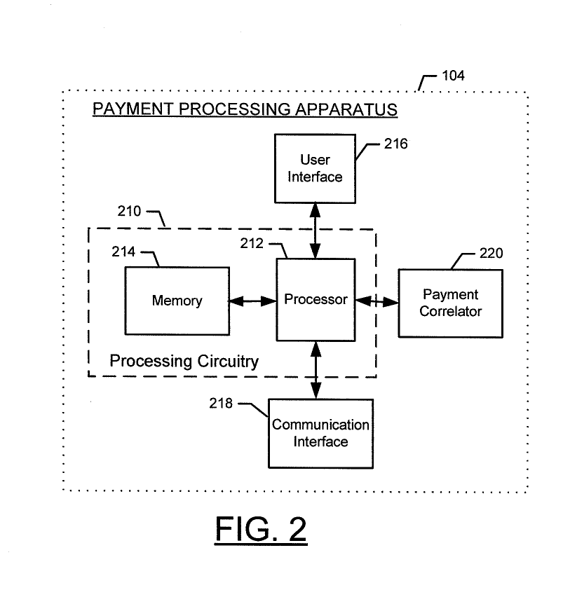

In some example embodiments, payment processing apparatus 104 may be embodied as or comprise one or more computing devices, such as, by way of non-limiting example, a server, configured to access network 100 and/or payment scanning system 102. In some example embodiments, payment processing apparatus 104 may be implemented as a distributed system or a cloud based entity that may be implemented within network 100. In this regard, payment processing apparatus 104 may comprise one or more servers, a server cluster, one or more network nodes, a cloud computing infrastructure, some combination thereof, or the like. Accordingly, in some example embodiments, a payment processing apparatus 104 may be configured to communicate with one or more payment scanning apparatuses 102 over the network 100 to receive scanned data. Additionally or alternatively, in some example embodiments, payment processing apparatus 104 may be directly coupled to a payment scanning system 102. An example embodiment of payment processing apparatus 104 is illustrated in FIG. 2 and is described in further detail hereinafter.

Continuing with FIG. 1, system 101 may also include an account information system 106 configured to maintain account details and/or other information relating to incoming payments. Account information system 106 may comprise one or more computing devices configured to implement an electronic accounting system for maintaining customer account information. In this regard, the account information system 106 may comprise one or more servers, a server cluster, one or more network nodes, a cloud computing infrastructure, some combination thereof, or the like that may be configured to store and/or provide access to electronic account information. Account information system 106 also may comprise a database of account information or may be configured to access such a database.

In some example embodiments, an account information system 106 may be maintained by a third party. Additionally or alternatively, an account information system 106 may be maintained directly by an entity overseeing the accounts. System 101 may comprise a plurality of account information systems 106 with which a payment processing apparatus 104 may interface via network 100. Additionally or alternatively, account information system 106 may be directly coupled to payment processing apparatus 104 to transmit account information. As another example, the account information system may be implemented on the payment processing apparatus 104 in some example embodiments.

Some embodiments of system 101 may include one or many payment posting systems 108. Payment posting system 108 may be capable of receiving account and payment information, as well as debiting and crediting accounts. Payment posting system 108 may comprise one or more computing devices, such as by way of non-limiting example one or more servers, a server cluster, one or more network nodes, a cloud computing infrastructure, some combination thereof, or the like that may be configured to store and/or provide access to electronic account information.

In some example embodiments, the payment posting system(s) 106 may be maintained by a third party, and/or maintained directly by the company responsible for the accounts. Payment posting system 108 may communicate with network 100 or be directly coupled to payment processing apparatus 104 to transmit data with and on behalf of payment processing apparatus 104. Additionally or alternatively, in some embodiments, a payment posting system 108 may be implemented on the payment processing apparatus 104.

Continuing with FIG. 1, system 101 may additionally and optionally comprise any number of user terminals 110, which may, for example, be embodied as a laptop computer, tablet computer, mobile phone, desktop computer, workstation, or other like computing device. A user terminal 110 may be remote from the payment processing apparatus 104 in which case the user terminal 110 may communicate with the payment processing apparatus 104 via network 100. In such embodiments, payment processing system 104 may be configured to provide a user interface, such as a web interface, that may be accessed by a user terminal 110 over network 100. Additionally or alternatively, the user terminal 110 may be implemented on payment processing apparatus 104.

In some embodiments, associated data and images of payment documents may remain in a database, such as may be stored on and/or which is otherwise accessible to payment process apparatus 104, from which information for a lockbox customer can be electronically retrieved over a network 100. Delivery of capture functionality without the need for a prior installation or setup in such embodiments enables distribution of the system to a larger number of user terminals 110, which may use a variety of browsers. Accordingly, setup and training times may be reduced, while reducing the possibility of unforeseen device conflicts. Also, by simplifying the number of components delivered to the user terminals 110, such example embodiments reduce the complexity over previous systems. The reduced complexity also benefits the user by reducing oversight complexity and associated process risk auditing costs.

FIG. 2 illustrates a payment processing apparatus 104 in further detail, in accordance with some example embodiments. However, it should be noted that the components, devices, and elements illustrated in and described with respect to FIG. 2 below may not be mandatory and thus some may be omitted in certain embodiments. Additionally, some embodiments may include further or different components, devices, or elements beyond those illustrated in and described with respect to FIG. 2.

Referring now to FIG. 2, processing circuitry 210 may be configured to perform actions in accordance with one or more example embodiments disclosed herein. In this regard, the processing circuitry 210 may be configured to perform and/or control performance of one or more functionalities of the payment processing apparatus 104 in accordance with various example embodiments. The processing circuitry 210 may be configured to perform data processing, application execution, and/or other processing and management services according to one or more example embodiments. In some embodiments, the payment processing apparatus 104 or a portion(s) or component(s) thereof, such as the processing circuitry 210, may be embodied as or comprise a chip or chip set. In other words, the mobile data capture apparatus 102 or the processing circuitry 210 may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The payment processing apparatus 104 or the processing circuitry 210 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 210 may include a processor 212 and, in some embodiments, such as that illustrated in FIG. 2, may further include memory 214. The processing circuitry 210 may be in communication with or otherwise control a user interface 216, a payment correlator 220, and/or a communication interface 218. As such, the processing circuitry 210 may be embodied as a circuit chip (e.g., an integrated circuit chip) configured (e.g., with hardware, software, or a combination of hardware and software) to perform operations described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of payment processing apparatus 104 as described herein. The plurality of processors may be embodied on a single computing device or distributed across a plurality of computing devices collectively configured to function as the payment processing apparatus 104. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA, or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the payment processing apparatus 104. The memory 214 may be configured to store information, data, applications, instructions and/or the like for enabling the payment processing apparatus 104 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets. Among the contents of the memory 214, applications may be stored for execution by the processor 212 to carry out the functionality associated with each respective application. In some cases, the memory 214 may be in communication with one or more of the processor 212, user interface 216, communication interface 218, or payment correlator 220 for passing information among components of payment processing apparatus 104.

The user interface 216 may be in communication with the processing circuitry 210 to receive an indication of a user input at the user interface 216 and/or to provide an audible, visual, mechanical, or other output to the user. As such, the user interface 216 may include, for example, a keyboard, a mouse, a joystick, a display, a touch screen display, a microphone, a speaker, and/or other input/output mechanisms. As such, the user interface 216 may, in some example embodiments, provide means for user control of payment processing operations, user review of payment information, user correction of payment information, viewing account or payment information, and/or the like. In some example embodiments in which the payment processing apparatus 104 is embodied as a server, cloud computing system, or the like, aspects of user interface 216 may be limited or the user interface 216 may not be present. In some example embodiments, one or more aspects of the user interface 216 may be implemented on a user terminal 110. Accordingly, regardless of implementation, the user interface 216 may provide input and output means to facilitate payment processing in accordance with one or more example embodiments.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable payment processing apparatus 104 to communicate with the account information system 106, the payment scanning system 102, and/or the payment posting system 108 via network 100. Accordingly, the communication interface 218 may, for example, include supporting hardware and/or software for enabling communications via cable, digital subscriber line (DSL), universal serial bus (USB), Ethernet, or other methods.

In some example embodiments, the processor 212 (or the processing circuitry 210) may be embodied as, include, or otherwise control a payment correlator 220. As such, the payment correlator 220 may be embodied as various means, such as circuitry, hardware, a computer program product comprising computer readable program instructions stored on a computer readable medium (for example, the memory 214) and executed by a processing device (for example, the processor 212), or some combination thereof. Payment correlator 220 may be capable of communication with one or more of the memory 214, user interface 216, or communication interface 218 to access, receive, and/or send data as may be needed to perform one or more of the functionalities of the payment correlator 220 as described herein.

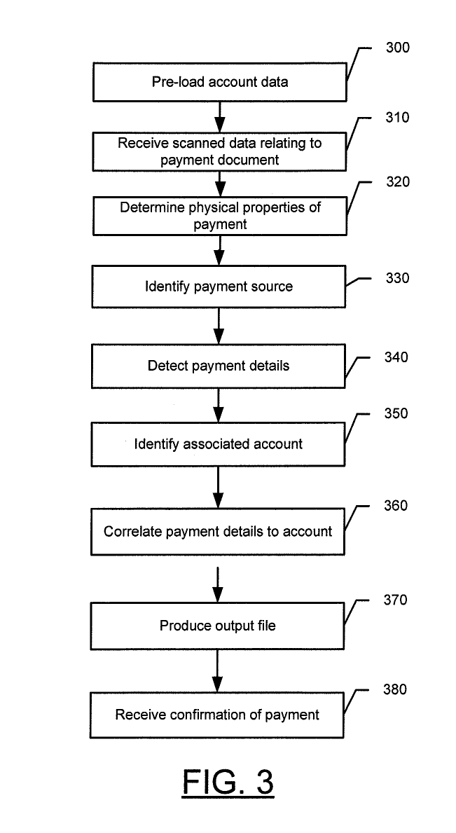

FIGS. 3, 4, 5, 7, 8, and 9 are flowcharts of operations according to some embodiments. Operations illustrated in FIGS. 3, 4, and 5 may be performed by a payment processing apparatus and, more particularly, may be performed by, with the assistance of, and/or under the control of one or more of the processing circuitry 210, processor 212, memory 214, user interface 216, communication interface 218, and payment correlator 220.

In FIG. 3, at operation 300, account data may be preloaded onto a payment processing apparatus, such as, for example, payment processing apparatus 104. The data may be provided by an account information system 106, and may be provided via a network, such as network 100, direct connection, or any other connection type. The preloaded data may be provided to and/or otherwise obtained by the payment processing apparatus in accordance with various methods, such as routine batch processes, manual syncs, real-time updates, and/or the like. The preloaded account data may be received by a communication interface, such as communication interface 218, interpreted by a payment correlator, such as payment correlator 220, and stored on memory, such as memory 214. As another example, in embodiments where an account information system, such as account information system 106, is implemented on the payment processing apparatus, the payment processing apparatus may have direct access to real-time account information as it is stored to the memory, for example, by an account information system.

According to some embodiments, the account information may include personal information such as names, addresses, phone numbers, social security numbers, or other identification numbers, customer numbers, other personal information, as well as billing data such as account balances, statement balances, recent payments, usage or service information, and/or any other data. The account information may also comprise past payment details such as payment sources, bank account information, and/or the like. The account information may be associated with credit card accounts, utility bills, subscription payments, homeowners' association dues, car loans, lines of credit, student loans, or any other entity receiving deposits or payments. In some embodiments, preloaded account information may comprise account information provided by a third party, such as a credit card company.

In some example embodiments, an account information system may be configured to produce files containing lists and/or tables of all expected payments and depositors, including payees, amounts, the payee's account number and other user-selected information. Files may describe any number or type of expected payments, payees, payers and/or depositors. These files may be produced at user-specified intervals and delivered to a designated storage location or otherwise made available to a payment processing system. The payment processing system may import and read the metadata.

At operation 310, a payment processing apparatus, such as the payment processing apparatus 104, may receive scanned data representative of information on the payment documents. In this regard, the scanned data may comprise images of one or more payment documents and/or digital data representative of characters and/or information on the payment documents. The scanned data may be provided by a payment scanning system, such as payment scanning system 102, and, similar to the data transmission of the account information system, may be transmitted via a network, direct connection, or other connection, by various methods such as routine batch processes, manual syncs, or real-time updates. The scanned data may be received by the communication interface, interpreted by the payment correlator, and stored to the memory. In embodiments where a payment scanning system is implemented on the payment processing apparatus, the payment processing apparatus may have direct access to local images such as may be stored in memory.

At operation 320, the payment correlator may be configured to determine physical characteristics of the payment documents. Operation 320, as well as other operations described hereinafter, may be triggered by a variety of techniques, including initiation of a process upon receipt of scanned data, accessing the scanned data and performing the operations during a routine batch process, and/or the like. The scanned data may comprise data representing a single payment instrument, or may additionally comprise a document set, such as a document set comprising a billing statement associated with account and/or billing information and data representing one or more related payment instruments. A payment document set may include multiple instruments intended to be credited to a single account, or multiple instruments intended for different accounts, and, if any, other scanned data representative of information of the payment documents. Some payment document sets may include a billing statement, multiple billing statements, or no billing statements. A payment document set may comprise any combination of payment instruments and billing statements and, if any, other scanned data. As such, physical characteristics of a payment may include a particular combination of payment instruments and billing statements that may be included in a payment document set. The physical characteristics of a payment document set may be determined by the payment correlator, and associated with the payment in the memory, and/or it may be readily provided along with the scanned data by the payment scanning system, such as other digital data representative of information of the payment documents.

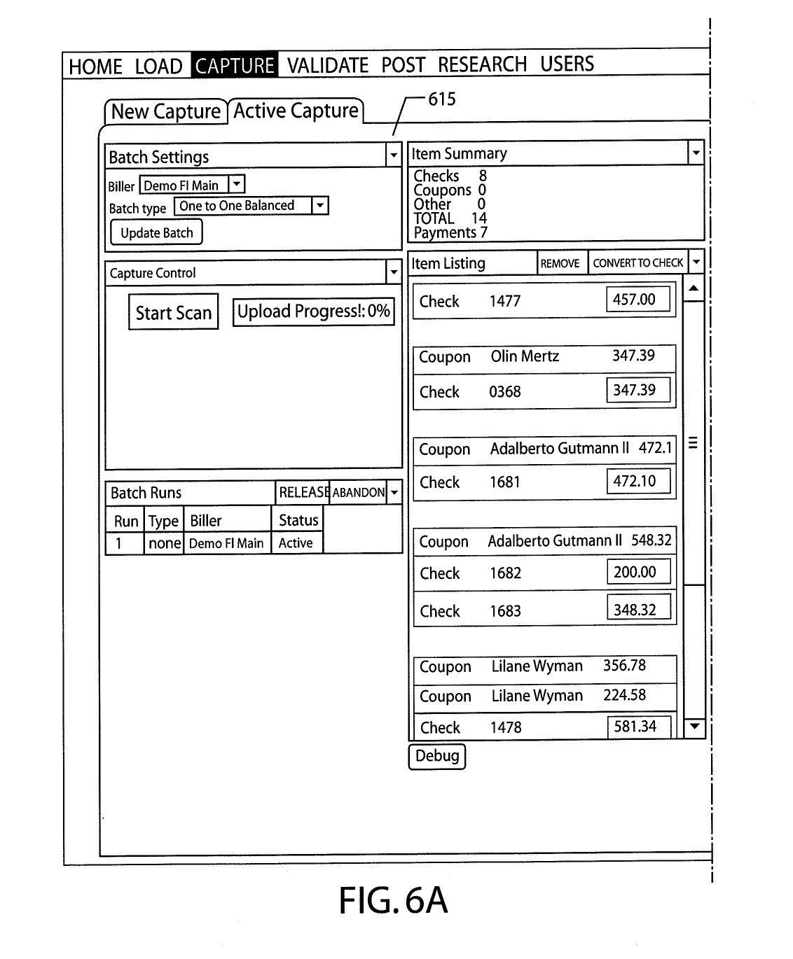

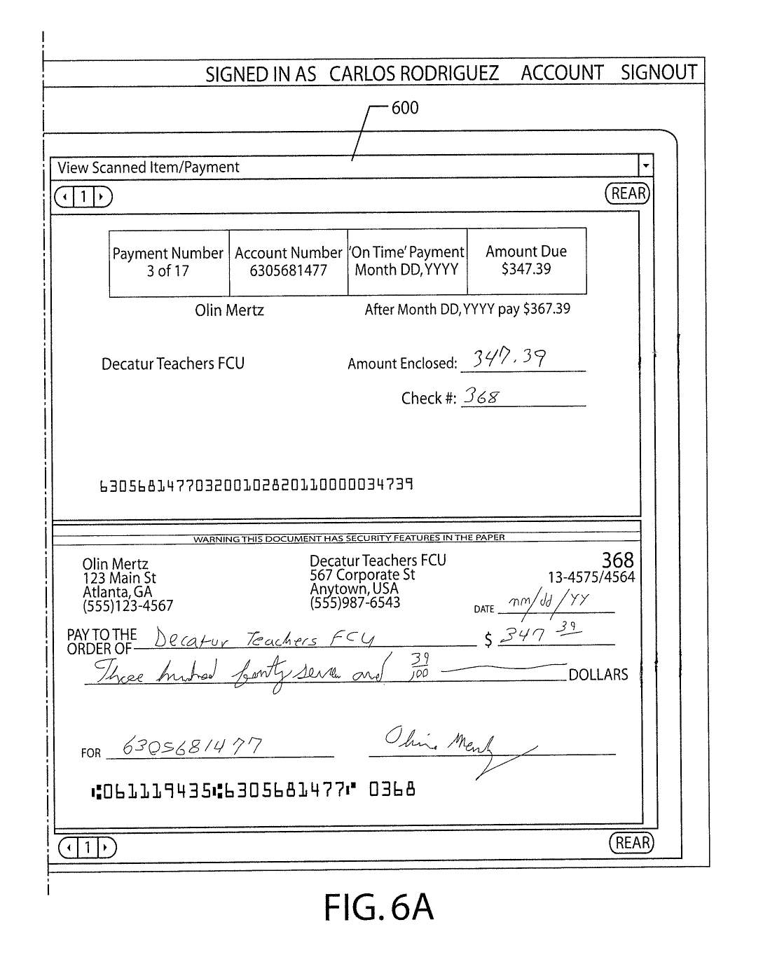

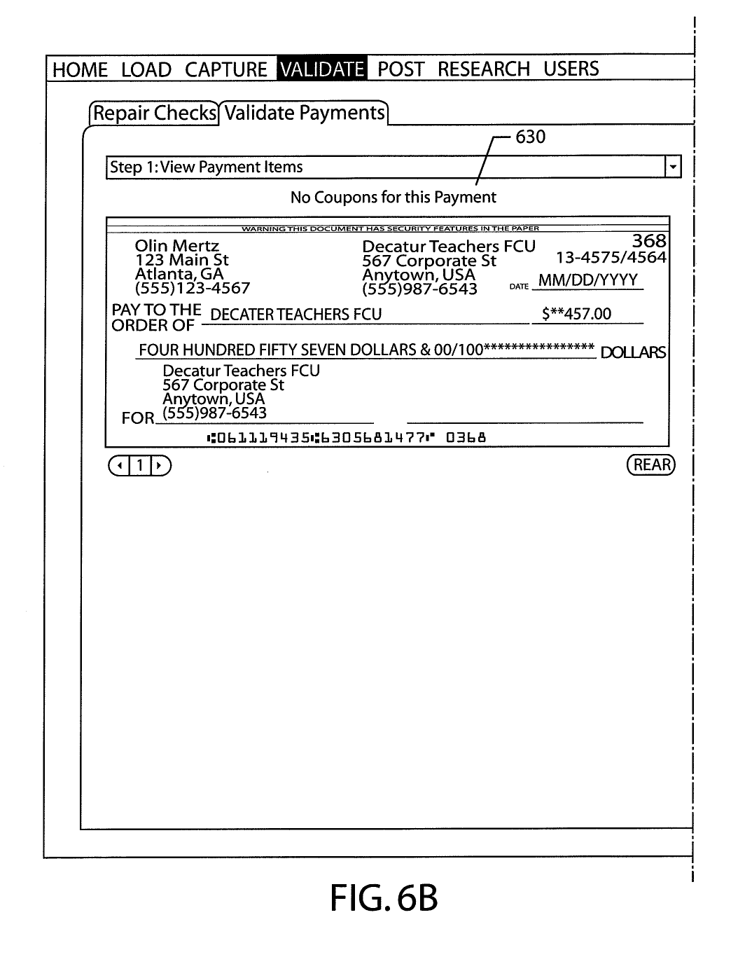

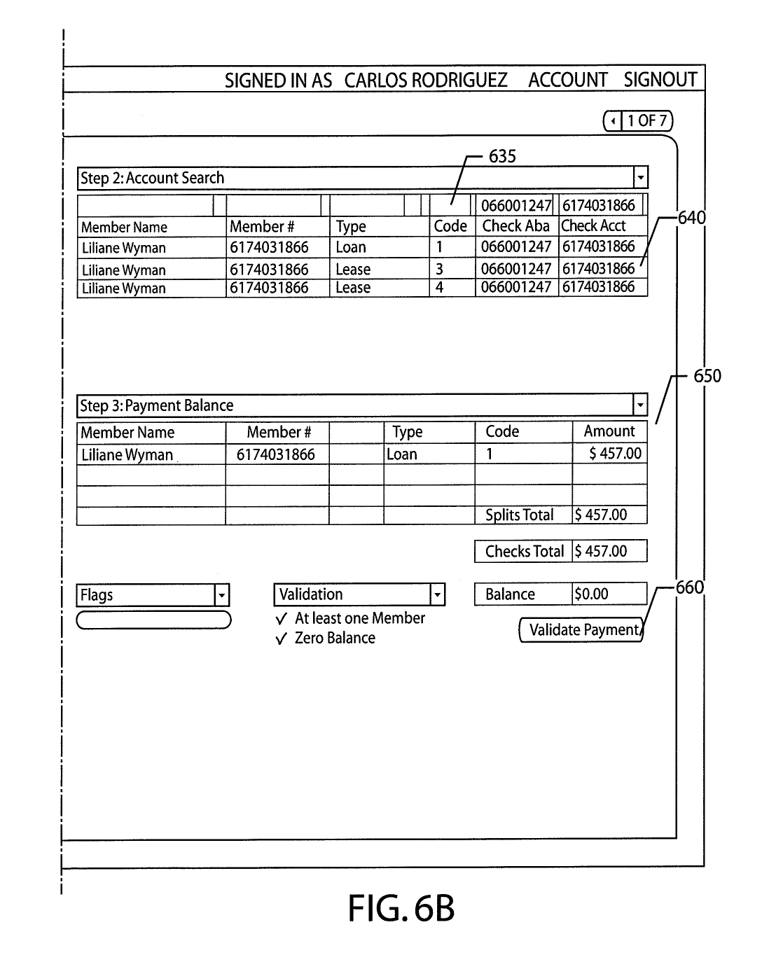

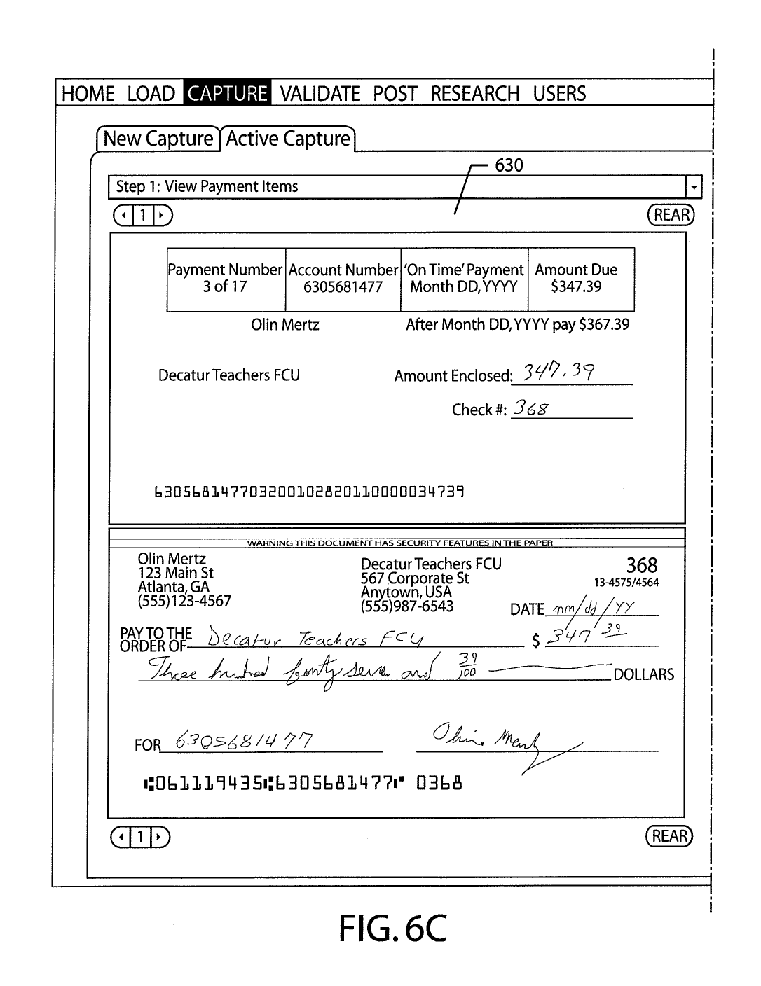

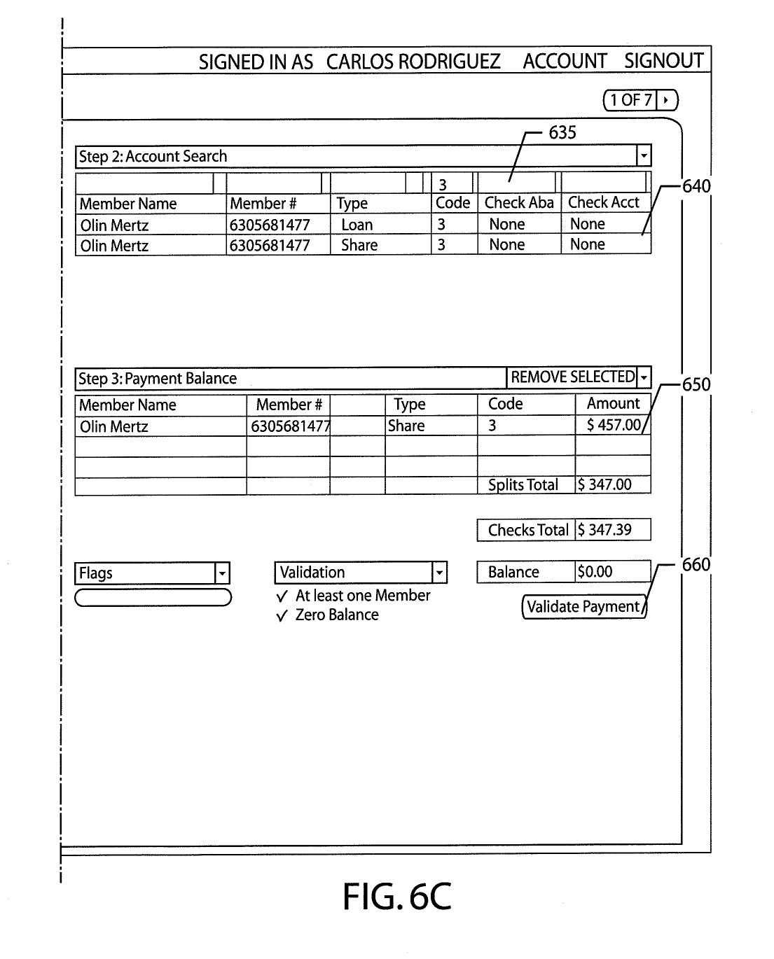

In some example embodiments, the payment processing apparatus may receive the scanned data pre-sorted according to physical characteristics. For example, in some embodiments, the payment documents may be sorted prior to being scanned, so that document sets are received by the payment processing apparatus in batches containing like physical characteristics. By way of non-limiting example, the sort categories may include one-to-one, multiples, and no billing statements. Furthermore, according to some embodiments, payment sort categories may include balanced and unbalanced, where balanced payments have a matching payment amount and bill amount on a billing statement, and unbalanced payments do not have a matching payment and bill amount. One-to-one balanced sort bundles may be made up of payments including one billing statement and one check for which the amounts on both the billing statement and the check are equal. One-to-one unbalanced may comprise those payments composed of one billing statement and one check and where the amounts on both are not equal. In some embodiments, an unbalanced payment may be flagged for manual validation that may be completed with the use of validation screens, such as those of FIGS. 6b and 6c, and as described in further detail herein. In some embodiments, the sort category of multiples includes those payments with any combination of multiple and single billing statements or checks. Finally, no billing statements may represent those payments arriving with no billing statement. As some example embodiments do not require detailed matching of the payment to the destination during sorting, pre-sort bundles may be quickly and efficiently assembled into groupings easily distinguishable by their physical properties. Employing this type of sort may reduce the incidence of human error and/or may reduce the number of presorts that may be required in present payment processing systems, such as those dependent on sorting by payment type, destination, and/or any other category. A reduction in the number of pre-sort bundles may help reduce the rate of pre-sort error incidents.

Continuing to operation 330, the payment processing apparatus may determine a payment source associated with a payment instrument or a plurality of payment sources such as in an instance where the physical characteristics signify multiple payment instruments. Payment documents scanned by a payment scanning system may include, but are not limited to personal checks, money orders, business checks, traveler's checks, cashier's checks, government checks, credit card charge authorization forms, and the like. Such payment documents may be used to make a payment towards credit card accounts, utility bills, subscription payments, homeowners' association dues, car loans, lines of credit, student loans, or any other entity receiving deposits or payments. The payment source may be identified by the payment correlator and associated to the payment in the memory, or may be provided by the payment scanning system, such as in those embodiments that that the payment scanning system is capable of detecting payment sources. The payment correlator may optionally utilize a billing statement in determining the payment source. In this regard, a billing statement may indicate a payment method, such an indication by checkmark, for example, of a payment source such as credit card, check, money order, or the like. The payment correlator may also determine other details on a billing statement, such as a provided check number, credit card number, or the like, to determine a payment source.

Moving on to operation 340 in FIG. 3, the payment correlator may extract payment details from the scanned data. In this regard, the payment correlator may, for example, be configured to apply any appropriate image processing algorithm to an image of a payment document to extract payment details from the image. Payment details may comprise a payment amount, account information for the account to which the payment is intended to post, bank account information for the bank account from which the payment will be made, such as, for example, bank account number, routing number, bank account name, bank account type, and/or the like. Payment details may additionally or alternatively comprise any other pertinent payment information. The payment correlator may utilize various methods to extract this information.

Additionally or alternatively, the information may be identified by the payment scanning system and communicated to the payment processing apparatus. The payment information may then be stored in memory, for example, and associated to the scanned data and/or payment document. According to some embodiments, payment documents may be scanned and submitted to the system as images and captured data. In some example embodiments, payment document data is read using an optical character recognition engine and/or MICR data (from the checks). The payment scanning system may comprise a universally-available scanner driver and document capture. It will be appreciated that data extracted from images may be done so utilizing various combinations of any data extraction and/or image detection techniques.

Given the payment details identified in operation 340, at operation 350, the payment processing apparatus may identify an account for which information was preloaded in operation 300, as being the intended account to credit. The payment correlator may employ a variety of approaches to accomplish account identification. This may include accessing the memory and comparing any combination of personal information, account information, bank account information, and/or the like associated with the payment to preloaded account data. According to some embodiments, the payment processing apparatus may utilize past payment information, such as any combination of a checking account number, routing number, name on checking account, or any other information to identify an intended payer and ultimately a correct account.

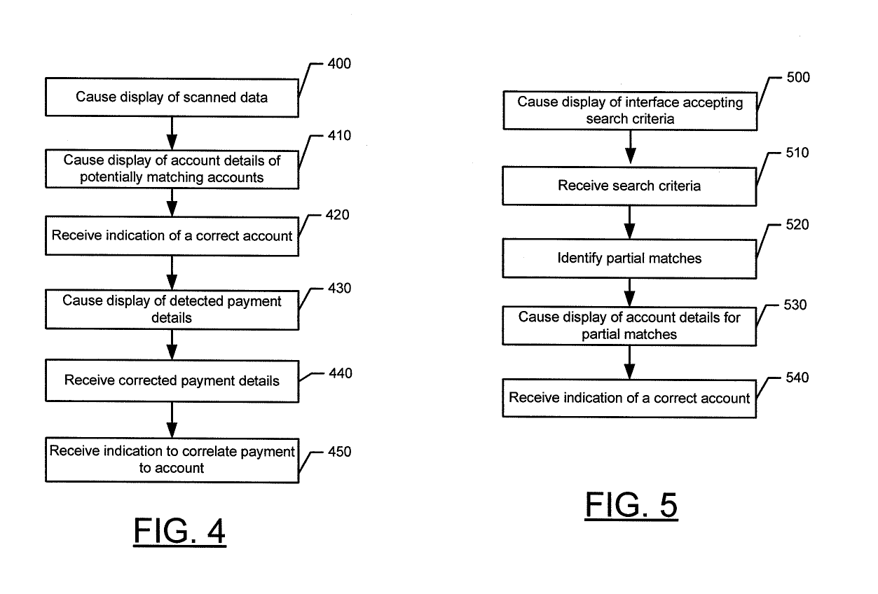

In some embodiments, the payment correlator may be configured to match scanned or extracted data against previously imported account data to obtain the proper crediting information associated with a given payment. Payment documents that read incompletely or are not available on the original payer document may be routed to a validation process, such as those illustrated in and described with respect to FIGS. 4 and 5.

In some embodiments where physical characteristics of a payment indicate the need for additional processing, operations 330-360 may be repeated for each payment instrument included in the payment. The payment may then be correlated with an account in memory at operation 360, by use of an account identifier or other pertinent account information.

In some example embodiments, at operation 370, the payment processing apparatus may optionally produce a payment output file or files that may comprise details necessary for a payment posting system, such as payment posting system 108, to post the payment. The output file(s) may comprise bank account information for an account from which money is to be debited, and a transaction amount. The output file(s) may also comprise details for a payee account to which the payment is to be deposited. Some payment output files may be generated to process payments towards credit card accounts, utility bills, subscription payments, homeowners' association dues, car loans, lines of credit, student loans, or any other entity receiving paper payments. The output file(s) may be generated in a format required by any such entity or as required by the payment posting system. In some embodiments the file may be generated in a format compatible with financial software such as, for example, Quicken®. The file(s) may be generated by the payment correlator and stored in memory and/or archived for long term storage and review. Additionally or alternatively, the payment processing apparatus may optionally produce payment output instructions that may be used by the payment posting system, such as to update one or more database records of the payment posting system, which the payment posting system then uses to post the payment. Associated data and images may remain in a database, from which information may be electronically retrieved over a network. Additionally, the file(s) may be communicated via a communication interface to the payment posting system. The output file(s) may be provided to the payment posting system by various delivery options and formats. By way of non-limiting example, an output file may be provided automatically by email, accessed via a web portal login page, sent or retrieved by a batch or streaming process, such as in an electronic data interchange (EDI), or sent and/or received by any other delivery method and provided in any format, such in an extensible markup language (XML).

In some embodiments, at operation 380, payment processing apparatus 104 may receive a confirmation from payment posting system 108 that a payment has posted. At operation 390, payment processing apparatus 104 may communicate a posted payment to account information system 106 to reflect the posted payment, and/or payment posting system 108 may communicate with account information system 106 either directly or via network 100 to update the account information with the posted payment.

Moving on to FIG. 4, in some embodiments, the payment processing apparatus may perform any of operations 400-450 in conjunction with operations 300-390. Data records that read incompletely and/or that are not otherwise available from processing the image of the original payee document may be automatically routed to a payment validation function. Operations illustrated in FIG. 4 may utilize a user interface implemented on the payment processing apparatus or on a user terminal, or on any combination thereof. An example display of a graphical user interface that may be used to facilitate payment processing is illustrated in FIGS. 6a-6c. FIGS. 6a-6c are provided as examples in accordance with some example embodiments and are not intended to be limiting. It will be appreciated that in alternative embodiments, a user interface may not be present, or may comprise some illustrated features presented in another format.

Area 615 of FIG. 6a is an example of a summary of payments awaiting processing. The payment processing apparatus may cause a document set to be displayed at operation 400, such as in area 600 of a display such as in FIG. 6a, or area 630 in FIG. 6b or 6c. FIG. 6b is an example of a user interface displaying a document set comprising one check and no billing statements in area 630. FIG. 6c is a user interface displaying a document set comprising one check and one corresponding billing statement in area 630. In some scenarios, operation 350 may result in multiple potential accounts, and the payment correlator may cause display of the potential accounts at operation 410, such as in area 640 of FIGS. 6b and 6c, and receive a user input at operation 420 indicating a correct account. Such an indication may be given, for example, by selection of an account in area 640.

In some embodiments, in an instance of a partial match of an account, an operator may select a displayed partially matching payer entry, and an operator may not need to provide key entry. As the imported account information may be used to perform the suggestion of account information, opportunities for key entry error may be reduced. The imported account data may have passed many data cleaning steps and may be in active use at its source. Accordingly, the preloaded account data may be trusted as valid. If an operator locates the correct account, the operator may select an entry, which may cause the payment to be validated. In a case of multiple items, the amount of the payment may be keyed, and possibly then only to verify the validity of the amount against that captured amount delivered by the scan process. By reducing the number of keystrokes a given operator expends, opportunities for misapplied keystrokes may be consequently reduced, improving accuracy and overall throughput.

In the case of a partial match, some embodiments of a payment correlator may utilize search algorithms to locate and cause display to the operator partial matches. The operator may use search capabilities to mine the data for a direct match to the payer's account records, comparing the data against a document set until a match is found. Even if no data matches initially, the operator may be able to perform a global or user-level restricted search against account information. When an operator locates the correct account, the operator may select the entry, thereby validating the payment.

In some example embodiments, the payment processing apparatus may also be configured to cause display of extracted payment details at operation 430. Extracted payment details, such as an amount, may be displayed for verification in area 650 of FIGS. 6b and 6c. The payment correlator may receive corrected or otherwise missing payment details at operation 440, as provided by a user, for example, at area 650, upon verifying the details against the payment and/or billing statement image. In some embodiments, the payment correlator may receive indication of a location of one or more payment details relative to a payment document. For example, while examining an image of a check, a user may visibly see an account number in a memo area of a check that the payment scanning system and/or payment correlator failed to extract. In such a scenario, the user may indicate the location of the payment detail(s), and the payment correlator may receive an indication to extract the data for use in the current transaction, or for use in future transactions to improve a data extraction process. In this regard, a user may indicate a location by, for example, highlighting an area of an image of a payment document with a mouse and/or by any other form of input. The payment processing apparatus may additionally receive indication at operation 450 that a user validation process is complete and to correlate payment details with an account, such as in some example embodiments, by an input or indicator 660.

Continuing to FIG. 5, in some embodiments, the payment processing apparatus may optionally perform any of operations 500-530 in any combination with operations 300-390 and/or 400-450. In some example embodiments, payment processing apparatus may cause display of an interface accepting search criteria for accounts at operation 500, and receive search criteria at operation 510. The payment processing apparatus may provide a search mechanism for any number of account identifiers, such as in display area 635 of FIGS. 6b and 6c. In this regard, a user may be provided with the ability to search accounts using a search tool which enables a user to input search criteria such as a sequence of one or more characters. The functional elements may be configured to use the search criteria to query any number of account data fields as characters are provided, such as in display area 635 and/or upon receiving an indication from a user that a search criteria is complete. Search fields may be provided for each of a respective plurality of data fields, such as in area 635. In some embodiments, search criteria may be provided via a single entry, but queried against any number of data fields associated with an account.

Regardless of the searching technique implemented, the payment correlator may be configured to accept any number of search criteria or search characters, apply them against account information to identify a list of potential account matches at operation 520, and then display them at operation 530, as illustrated in area 640 of FIGS. 6b and 6c. Embodiments whose payment processing apparatus utilizes searching as individual characters are provided may update the list of potential account matches as each character is provided. Additionally, in some embodiments, the payment processing apparatus may receive indication of the correct account, at operation 540, to correctly associate a payment and account.

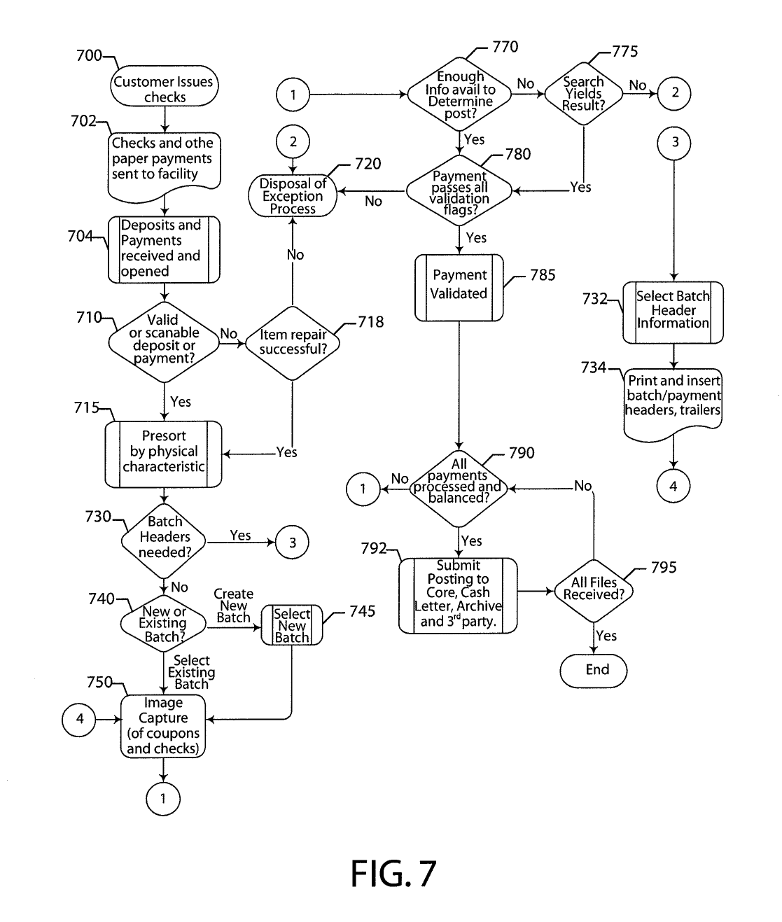

An additional flowchart according to some example embodiments is illustrated in FIG. 7. A customer may issue a check and send it to a mail processing facility at operations 700 and 702. At operations 704 deposits and payments are received and opened. At operation 710, a processing apparatus, such as processing apparatus 104, may detect whether the items in a piece of mail are valid and able to be scanned. If the items are able to be scanned, according to some example embodiments, at operation 715, payment document sets may be presorted by physical characteristics. At operation 718, an individual may repair, modify, or otherwise adapt an item to put it in a state that can be validated; otherwise, the item may be sent to a manual process, referred to as a “disposal of exceptions process,” at operation 720. In repairing an item, field values that may not have been correctly captured may be corrected.

Continuing with a scenario of an item ready to be scanned, at operation 730, payments are identified as needing batch headers or not. If a batch header is needed, at operation 732, the correct batch header information is identified, and, at operation 734, batch headers are inserted into an output file for the data to be accurately interpreted at a later time by, for example, a payment posting system, such as payment posting system 108.

Continuing to operation 740, the payment processing apparatus may determine if a new batch file needs to be created, and if so, create a new file at operation 745. In this regard, in some example embodiments, when a paper batch file header is read, a new batch may be generated automatically, and all items following the batch file header prior to a batch file trailer (if one exists) and/or subsequent paper batch file header (if one exists) may belong to the new batch. At operation 750, images may be captured. At operation 765, the payment processing apparatus may initiate a validation process, which may comprise any of the operations 300-380, 400-450, and 500-540, as described above.

Once a payment has been validated, the payment processing apparatus may determine at operation 770 if the data is in an adequate state to initiate posting a payment. If not, the payment processing apparatus may continue to operation 775, which may comprise any of operations 400-450 or 500-540 to assist a user in providing accurate payment information and an account.

Continuing to operation 780, the payment processing apparatus may run additional validations, and upon determining a transaction is valid, a user may give a final validation at operation 785. At operation 790, a user may ensure that all received payments are balanced. At operation 792, in some example embodiments, transactions may be submitted to a destination system, such as, for example, an archive, accounting system (e.g., a “core,” or central accounting system; and/or other accounting system), an account(s) system that may be used by a customer (e.g., a “Cash Letter” system), and/or any other systems, such as, one or more systems maintained by third parties. In some embodiments, images may be sent to an archive and stored for future retrieval. At operation 795, the processing apparatus may ensure files were received by an intended recipient.

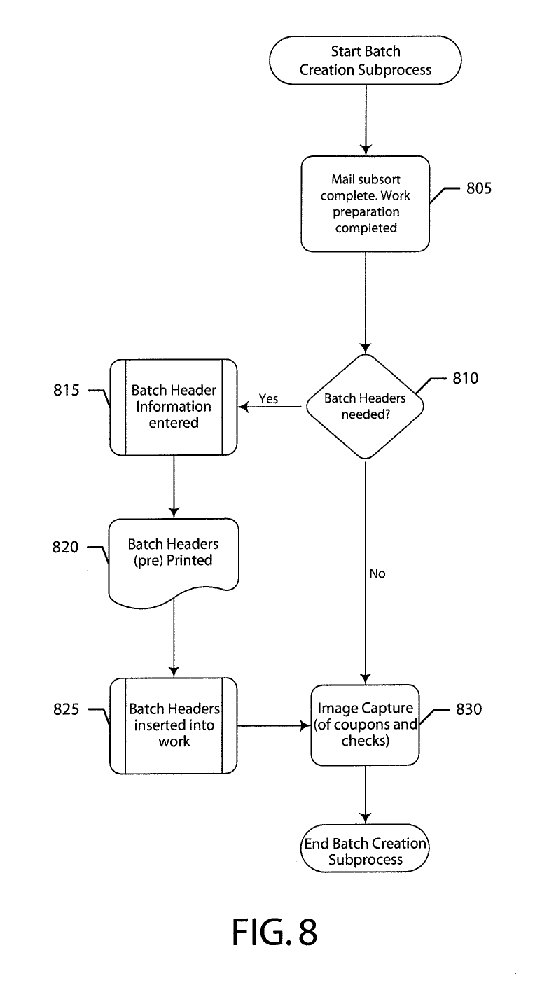

FIG. 8 is an additional flowchart according to some example embodiments, illustrating a batch creation sub-process. Operation 805 ensures the mail has been sorted as required by a payment scanning system, such as payment scanning system 102, and any other required setup is complete. If it is determined that batch headers are needed at operation 810, the batch header information may be entered at operation 815. Batch headers may be preprinted at operation 820, and inserted into work at operation 825. Continuing to operation 830, for documents requiring or not requiring batch headers, the payment documents may be scanned and images captured.

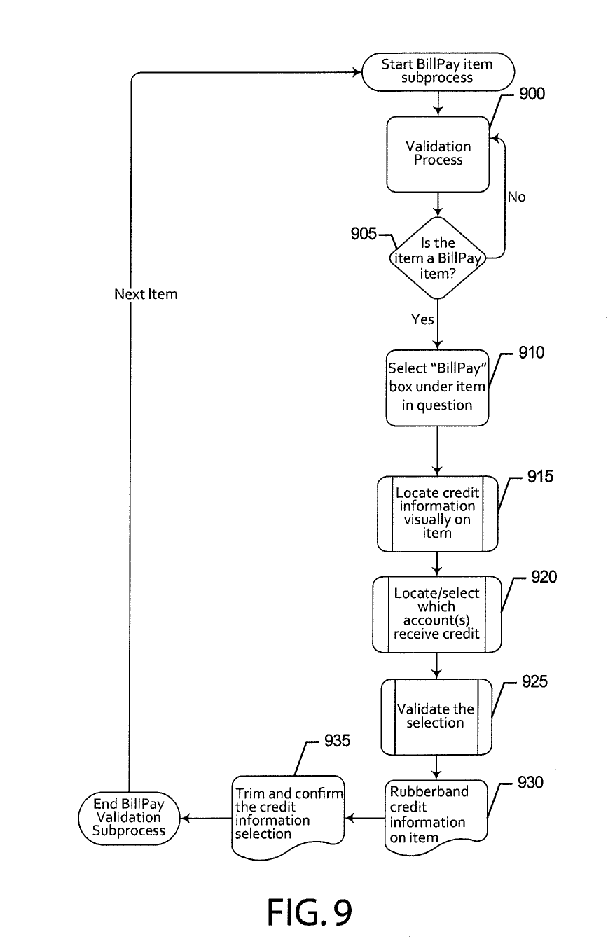

FIG. 9 is an additional flowchart according to some example embodiments, illustrating a sub-process for processing a bill pay item. At operation 900, the item may be validated, by use of a display such as those of FIGS. 6b and 6c. As described above, the user interface illustrated in FIGS. 6b and 6c allows a user to manually validate and/or change payment information to match physical payment information on an image. At operation 905, if the item is determined to be a bill pay item, a user may select “BillPay” for that particular item on a user interface, such as user interface 216. A user may then locate payment information at operation 915 and use the information to identify and select a correct account at operation 920. At operation 925, the selection may be validated. Continuing to operation 930, payment information may be rubberbanded, or selected. In this regard, a user may rubberband payment information by selecting a target area on a display and indicate, such as by way of user interface 216, that the selected area contains payment information. At operation 935, the payment information selection may be trimmed to remove extraneous information, and the payment information may be displayed for confirmation.

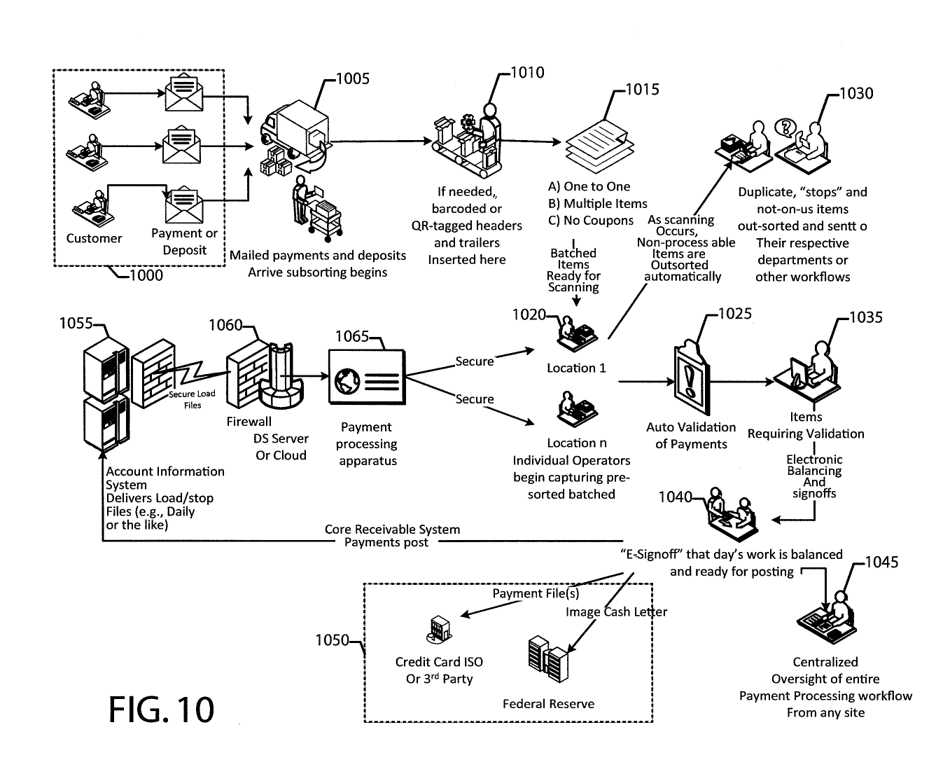

In some example embodiments, as illustrated in FIG. 10, customers may mail in payments or deposits at operation 1000. The mail may arrive at a centralized location and at operation 1005 the payments may be presorted. At operation 1010, payments may be barcoded. For example, quick response (QR) code, linear barcode, or other appropriate type of barcode headers and/or trailers may be inserted. A barcode, and/or the like, may be read by a payment scanning system, such as for example, payment scanning system 102, providing additional instructions. For example, a header may comprise instructions to create a batch and begin capturing item images. Additionally or alternatively, a trailer may instruct a payment scanning system to be marked “closed,” meaning all items in a batch are captured. At operation 1015, items may be batched according to physical characteristics of the document sets, such as, for example, in this scenario, one-to-one, multiple items and no billing statements. At operation 1020 images may be captured by a payment scanning system, such as payment scanning system 102, in this example, at any number of terminals, and payment details may be extracted. At operation 1030, items recognized as being in the wrong queue, or items needing special attention, may be routed to various other locations. Some items may be automatically validated at operation 1025, such as in scenarios where, for example, detection of a dollar amount on a check matches an amount owed, or any other scenario in which a payment correlator, such as payment correlator 220, successfully extracts payment information. Some items may require additional validation at operation 1035. An example payment document needing additional validation may be one in which a payment is unreadable by machine, or stray marks result in multiple potential matches for any pertinent account data fields. The additional validation may comprise any combination of operations, and may, for example, include one or more of operations 400-540 illustrated in FIGS. 4 and 5. The validation may additionally or alternatively comprise other validation operations. At operation 1040, an e-signoff may occur to signify that a portion of data is validated, balanced, and ready for posting. At operation 1050, payment files may be generated and sent to a third party responsible for debiting and crediting each payment to the appropriate accounts as indicated in the files, and an image cash letter may be generated to communicate digital images of checks.

At operation 1055, an account information system, such as account information system 106, may deliver load/stop files. The load/stop files may, for example, be delivered periodically, such as daily. Additionally or alternatively, the load/stop files may be delivered on demand, or otherwise as needed. Such load/stop files may include instructions regarding specific payers or accounts, such as to not accept payments from a payer or account. Payments associated with items on a load/stop file may be routed to a manual process for further processing. Continuing to operation 1060, the account information is communicated to the processing payment apparatus, which in this particular example may be a server or cloud computing system. The account information may transmitted to a payment processing apparatus 1065, such as payment processing apparatus 104, which may be for example, configured to implement a web-based lockbox application. During the process, at operation 1045, a payment processing workflow may be supervised remotely. Operation 1045 may provide for final approval of payment posting data and output file creation.

FIGS. 3, 4, 5, 7, 8, and 9 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 214) storing instructions executable by a processor in the computing device (for example, by the processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, a payment processing apparatus 104 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a payment processing apparatus 104 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for processing payments comprising processing circuitry configured to cause the apparatus to at least:
prior to receiving scanned data, preload account data, wherein the account data comprises at least receiving account data;
receive the scanned data derived from scanning of at least one payment document;
extract payment details from the scanned data;
identify at least one receiving account associated with the payment document based at least in part on the preloaded receiving account data and the extracted payment details; and
correlate the payment details to the receiving account.

2. An apparatus according to claim 1 wherein the at least one payment document comprises a payment document set comprising at least one billing statement and at least one payment instrument.

3. An apparatus according to claim 1 wherein the preloaded account data comprises information regarding one or more expected payments.

4. An apparatus according to claim 1 wherein the preloaded account data comprises previous payment information associated with at least one previously received payment, and wherein identifying a receiving account comprises identifying a receiving account at least in part by correlating the payment details with the previous payment information.

5. An apparatus according to claim 1 wherein the processing circuitry is further configured to identify at least one payment source of the payment document.

6. (canceled)

7. An apparatus according to claim 1 wherein the processing circuitry is further configured to cause the apparatus to generate a payment posting output file containing the correlated payment details.

8. An apparatus according to claim 1 wherein the processing circuitry is further configured cause the apparatus to:
cause display of the scanned data;
cause display of receiving account details associated with an identified receiving account;
cause display of the extracted payment details;
receive an indication of an error receive corrected payment details; and
receive an indication to correlate the corrected payment details to the receiving account.

9. An apparatus according to claim 1 wherein the processing circuitry is further configured to cause the apparatus to identify a receiving account at least in part by:
identifying a plurality of potential receiving accounts based on at least the extracted payment details and the preloaded account data;
causing display of receiving account information associated with the potential receiving accounts; and
receiving a selection of one of the potential receiving accounts.

10. An apparatus according to claim 1 wherein the processing circuitry is further configured to cause the apparatus to identify a receiving account at least in part by:
receiving search criteria;
identifying at least one potential receiving account having associated receiving account information that at least partially matches the search criteria;
causing display of the at least one potential receiving account; and
receiving a selection of one of the potential receiving accounts.

11. A method for processing payments comprising:
prior to receiving scanned data, preloading, by processing circuitry, account data, wherein the account data comprises at least receiving account data;
receiving the scanned data derived from scanning of at least one payment document;
extracting payment details from the scanned data;
identifying a receiving account associated with the payment document based on at least in part the preloaded receiving account data and the extracted payment details; and
correlating the payment details to the receiving account.

12. A method according to claim 11 wherein the at least one payment document comprises a payment document set comprising at least one billing statement and at least one payment instrument.

13. A method according to claim 11 wherein the preloaded account data comprises information regarding one or more expected payments.

14. A method according to claim 11 wherein the preloaded account data comprises previous payment information associated with at least one previously received payment, and wherein identifying a receiving account comprises identifying an account at least in part by correlating the payment details with the previous payment information.

15. (canceled)

16. A method according to claim 11 further comprising:
causing display of the scanned data;
causing display of account details associated with an identified account;
causing display of the extracted payment details;
receiving an indication of an error;
receiving corrected payment details; and
receiving an indication to correlate the corrected payment details to the account.

17. A method according to claim 11 wherein identifying a receiving account comprises:
identifying a plurality of potential receiving accounts based on at least the extracted payment details and the preloaded receiving account data;
causing display of receiving account information associated with the potential receiving accounts; and
receiving a selection of one of the potential receiving accounts.

18. A method according to claim 11 wherein identifying a receiving account comprises:
receiving search criteria;
identifying at least one potential receiving account having associated receiving account information that at least partially matches the search criteria;
causing display of the at least one potential receiving account; and
receiving a selection of a receiving account from the displayed at least one preloaded receiving account.

19. A method according to claim 11, where the method is performed by a web-based system.

20. A computer program product for processing payments comprising at least one non-transitory computer-readable medium having computer-readable program instructions stored therein, the computer-readable program instructions comprising instructions, which when performed by an apparatus, are configured to cause the apparatus to at least:
prior to receiving scanned data, preload account data, wherein the account data comprises at least receiving account data;
receive the scanned data derived from scanning of at least one payment document;
extract payment details from the scanned data;
identify a receiving account associated with the payment document based on at least in part the preloaded receiving account data; and
correlate the payment details to the receiving account.

21. A system for processing payments comprising:
a scanning apparatus configured to cause the apparatus to at least:
scan at least one payment document; and
an apparatus for processing payments configured to cause the apparatus to at least:
prior to receiving scanned data, preload account data, wherein the account data comprises at least receiving account data,
receive the scanned data derived from scanning of at least one payment document;
extract payment details from the scanned data,
identify at least one receiving account associated with the payment document based at least in part on the preloaded receiving account data, and
correlate the payment details to the receiving account.

22. The method according to claim 11, wherein the scanned data does not include data explicitly identify a receiving account, and at least one payment document comprises a payment document set comprising at least one payment instrument and none of a billing statement or a payment coupon.

23. The method according to claim 11, wherein the receiving account data comprises at least a billing account number and wherein the billing account number is not provided in the scanned data.
